(19) United States
(12) Patent Application Publication
(10) Pub. No.: US 2004/0122937 A1
(43) Pub. Date: Jun. 24, 2004

(54) System and method of tracking messaging flows in a distributed network

(75) Inventors: Jack C. Huang, Flushing, NY (US); Revelino M. Pascual, New York, NY (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/322,919

(22) Filed: Dec. 18, 2002

(51) Int. Cl. G06F 15/173

(52) U.S. Cl. 709/224

(57) ABSTRACT

A system and method for tracking message flows throughout a distributed network using mobile surveillance agents (MSAs). The system comprises a repository of mobile surveillance agents (MSAs), wherein each MSA includes program code for monitoring a client program at a remote node in the distributed network and generating a surveillance report; a deployment system for deploying the MSAs to remote nodes; and a local intelligence contact (LIC) preloaded at each node for receiving a deployed MSA at the node.

### BACKGROUND OF THE INVENTION

1. Technical Field

The present invention relates generally to message tracking over a network, and more specifically to a distributed message tracking architecture that deploys and configures tracking tools across an array of programs running at disparate locations on a computer network.

2. Related Art

Through technology exploitation, many complex interactions among application processes are possible. An application process might perform distributed processing for one or more different applications. These applications might, in turn, depend on one another. Processing might be simultaneous or serial, and might involve several application processes working together. The application processes might have a hierarchical or network relationship, or they might be related in some way.

A distributed system may appear as one local machine to the end-user while in reality, the user's transaction may be transparently routed across vast networks of heterogeneous computers. Data may actually be moved across organizational and geographic boundaries. With ends in two different organizations, application support must be coordinated across both.

In this environment, support for a network of many applications with potentially hundreds of point-to-point connections is very costly, time consuming and introduces significant delays in problem analysis and resolution. The complexity of information flow makes it extremely difficult to pinpoint the root cause of failures.

A popular method for tracking the flow of messages (i.e., transactions) across networks is by including statements in sections of the source code where the calls to messaging interfaces take place, explicitly stating that the human readable text is to be written to a log. Because the message tracking code is intertwined with code that relates to the program's primary purpose, this method is not very flexible or adaptable. Whenever logging schemes change, code modifications to functional programs are required, exit routine parameters must be changed and programs recompiled, and all programs must be retested.

Moreover, since the message logs are often treated as a passive entity and are stored in a designated file or database, log entries accumulated over time may consume considerable system resource in the form of processor cycles and memory usage, and may become a potential cause of system problems themselves if they exceed their space allocation.

Accordingly, a need exists for a more robust system that can track message flows across a distributed network.

### SUMMARY OF THE INVENTION

The present invention addresses the above-mentioned problems, as well as others, by providing a specialized facility that will distribute message monitoring programs across a network to designated nodes (e.g., servers, endpoints, devices, etc.). When the monitoring program, referred to herein as a mobile surveillance agent (“MSA”), reaches the appropriate node, it will install itself and start monitoring only specified transactions.

In a first aspect, the invention provides a system for implementing message flow monitoring in a distributed network, comprising: a repository of mobile surveillance agents (MSAs), wherein each MSA includes program code for monitoring a client program at a remote node in the distributed network and generating a surveillance report; a deployment system for deploying the MSAs to remote nodes; and a local intelligence contact (LIC) preloaded at each remote node for receiving a deployed MSA at the remote node.

In a second aspect, the invention provides a method for monitoring message flows in a distributed network, comprising: creating a mobile surveillance agent (MSA); storing the MSA in a repository; loading a local intelligence contact (LIC) at a remote node in the distributed network; deploying the MSA to the remote node using the LIC to coordinate the deployment; monitoring a client program at the remote node with the MSA; and generating a surveillance report from the MSA.

In a third aspect, the invention provides a program product stored on a recordable medium, which when executed, implements message monitoring over a distributed network, wherein the program product comprises: means for storing a plurality of mobile surveillance agents (MSAs), wherein each MSA includes program code for monitoring a client program at a remote node in the distributed network and generating a surveillance report; means for deploying the MSAs to remote nodes; and means for coordinating installation of a deployed MSA at the remote nodes.

In a fourth aspect, the invention provides an architecture for monitoring messages across a distributed network, comprising:

(a) a server, wherein the server includes: a system for creating mobile surveillance agents (MSAs); a repository for storing the MSAs; and a deployment system for deploying MSAs throughout the distributed network;

(b) a plurality of remote nodes within the distributed network, wherein each remote node includes: a client program executing on the remote node; and a local intelligence agent for coordinating an installation of an MSA deployed to the remote node, and for distributing messages from the client program to the MSA installed at the remote node; and

(c) at least one log target for receiving surveillance reports from MSAs deployed throughout the distributed network.

The proposed architecture consists of a “stealth” message tracking tool that can be easily deployed and configured across an array of programs running at disparate locations on a computer network without the awareness of the running programs. By separating the tracking mechanism from the application's functional code, there is no disruption to the application itself if logging schemes are changed.

If changes must be made as to where log entries will be stored or what type of messages must be tracked, this architecture provides an easy, automated process for fine-tuning the message tracking process as system conditions change. For example, a problem such as database overflow can be easily solved by using this architecture to instruct the logging program to divert the log traffic to an alternate server.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a mobile surveillance agent system in accordance with the present invention.

FIG. 2 depicts an agent deployment package in accordance with the present invention.

FIG. 3 depicts a logic flow diagram for installing an MSA in accordance with the present invention.

FIG. 4 depicts an exemplary flow using a covert LIC in accordance with the present invention.

FIG. 5 depicts an exemplary flow using a proxy LIC in accordance with the present invention.

FIGS. 6-7 depict an exemplary implementation of an ICA in accordance with the present invention.

### DETAILED DESCRIPTION OF THE INVENTION

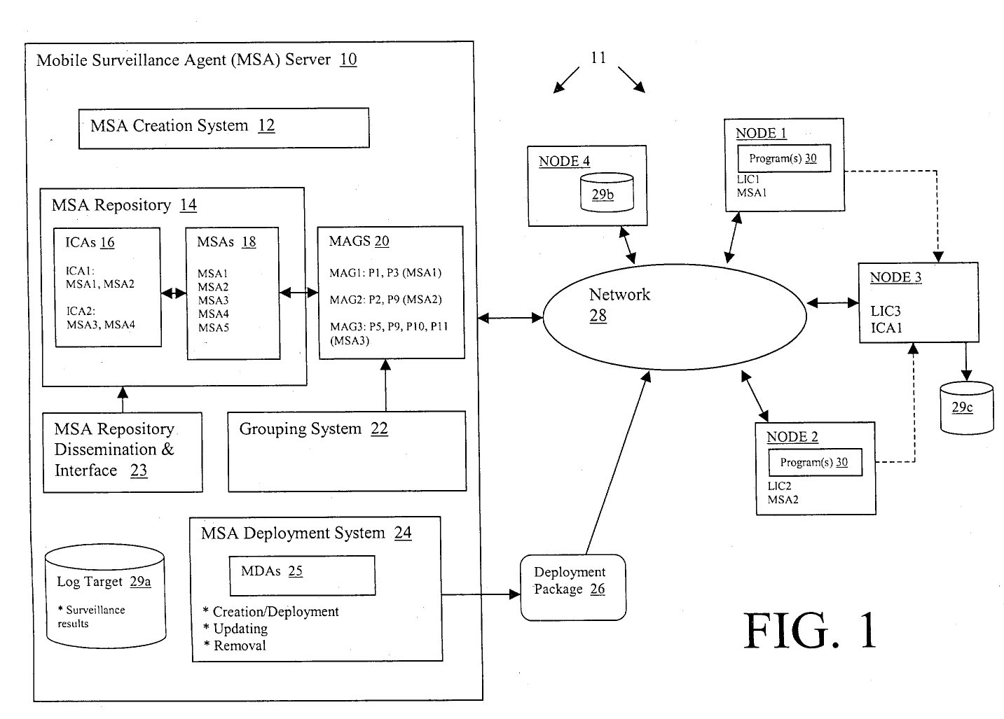

Referring now to the drawings, FIG. 1 depicts an exemplary architecture 11 for tracking messages across a network 28 in accordance with the present invention. Network 28 comprises a plurality of nodes, with each node representing a device that is in communication with the network. Architecture 11 includes a mobile surveillance agent (“MSA”) server 10 that is linked to network 28. Central to architecture 11 are the use of programs referred to herein as MSAs 18. An MSA is a program that, when loaded/linked by a client program 30 at a remote location in the network 28, reports messaging activities in a fashion prescribed by specified logging parameters. A client program 30 may comprise any type of program running at a node within the network 28 that generates information capable and/or desirable of being captured. For example, Node 1 may include a client program 30 comprised of an online ordering system and Node 2 may include a client program 30 comprised of an order fulfillment system. Information targeted for capture may include, for example, transmissions regarding completed orders, failed orders, shipped orders, messages to client programs at other nodes, etc.

MSAs 18 are managed and deployed by MSA server 10, which is likewise implemented at one or more nodes within network 28. MSAs are initially created by MSA creation system 12 to include code that determines what types of messages will be tracked and how they will be tracked. Namely, each MSA includes a set of parameters that can be tailored for a particular surveillance need. Details of these parameters are described below.

After an MSA is created, it is stored in an MSA Repository 14, where it awaits deployment. The MSA Repository 14 may include a repository interface and dissemination system 23 that disseminates information about the repository's MSAs 18 and provides an interface to manage the MSAs 18, including facilities for cloning, modifying, adding and deleting MSAs 18.

For easy deployment, client programs 30 from nodes that share some common messaging characteristic can be placed into an MSA Assignment Group (“MAG”) by a Grouping System 22. An MSA capable of monitoring the MAG is then extracted from the MSA Repository 14 and deployed to the MAG. Thus, for example, it can be seen that a set of MAGS 20 are created, with each MAG (e.g., MAG1) having an MSA (e.g., MSA1) that will be used by a group of client programs (e.g., P1, P3). Thus, using MAGs, a single MSA can be installed on each node associated with a group of common programs. The MSA program code can be replaced on the group level, and the members of the group can be automatically updated. Removing an MSA from the group level uninstalls MSA code from all group members.

MSAs 18 are deployed throughout the network using MSA Deployment System 24, which utilizes MSA Deployment Agents (MDAs) 25 to handle the task. MSAs are delivered over the network 28 via a deployment package 26 generated by the MSA Deployment System 24. Each node that is a target for receiving an MSA includes a local intelligence contact (“LIC”), which facilitates the installation of the MSA.

The MDA 25 recognizes the association of an MSA to a MAG and sends the MSA code through the network 28 to the LIC associated with each client program 30. The MDA 25 oversees the proper installation of an MSA at each node and notifies users of successful installation or errors. The MDA 25 also monitors the MSA Repository 14 and reflects changes to an MSA at pertinent client programs 30. If an MSA is removed from the MSA repository 18, the MDA is responsible for ensuring its complete removal through the local intelligence contacts (LICs).

To create and deploy an MSA:

1. A user creates the Mobile Surveillance Agent (MSA) by instantiating and specifying the logging parameters. Once created, the agent is stored in the MSA Repository 14.

2. Using a UI (user interface) or API (application programming interface), a user or program creates groupings, i.e., MAGs, of client programs 30.

3. The MSA is assigned to a new or existing MAG.

4. Through the MDA 25, the MSA is distributed to all member nodes of the MAG.

5. The MSA starts running and operates based on its logging parameters.

To update an MSA:

1. An MSA residing in the MSA repository 14 is modified.

2. MDA 25 detects this change and resends MSA to the nodes.

3. The Local Intelligence Contact (LIC) receives the updated MSA and replaces its local instance.

To remove an MSA:

1. An MSA is disassociated from a MAG, or an MSA is removed from the MSA Repository 14.

2. The MDA 25 notifies the LIC, which shuts down the target MSA. The MSA is then removed.

Each MSA can lie dormant at a node in “deep cover” mode for an indefinite period of time until it is called into action by a set of predefined surveillance triggers. If triggered, it is loaded into active memory and executes. In deep cover mode, it can be physically installed or can reside only in a remote repository. If it is not already installed, an MSA may be downloaded on demand when activated by a trigger.

MSAs can conduct surveillance in two modes: covert and proxy. In covert mode, the MSA intercepts and logs messages without intervention by the client program 30. The client program 30 may not even be aware that its message activity is being logged. Alternatively, the MSA can act as a passive proxy of message logging, allowing the client program 30 to dictate what to include in the log. This architecture can be adapted to either surveillance model based on the circumstances.

Data collected by each MSA, i.e., surveillance results or logs, may be forwarded to one or more log targets 29a, 29b, 29c located anywhere within the network 28. For example, in FIG. 1, the MSA data may be distributed to log target 29a at the MSA server 10, to log target 29b at Node 4, and/or log target 29c at Node 3. Moreover, each log target may be used for a different purpose, i.e., to collect different types of surveillance results. Log targets may comprise any type of memory storage system capable of holding the surveillance results, which) generally comprise a set of log entries.

As noted, each MSA contains specifications or logging parameters on how the message tracking is to take place. Based on these parameters, each MSA can be tailored to report only a specific type of messaging activity to specific locations. These message tracking specifications may include the following parameters:

Surveillance Sources:

The set of queues utilized by the client program(s) 30 that are monitored by an MSA.

Surveillance Log Targets:

A set of messaging channels set up automatically when the MSA are installed at the nodes. Log entries are delivered through these channels to a remote program or data store.

Surveillance Report Mapping:

This provides decision logic on how to interpret the messages being monitored, what information to extract from these messages, and what to include and how to include the information in the logs.

Surveillance Triggers:

Decides what circumstances will initiate/terminate surveillance activity.

1. Timer Triggered—surveillance takes place at predefined times.

2. Event Triggered—different levels of surveillance activity can be triggered by different events, such as interruptions in the local network connection or if the processing time exceeds a certain limit.

3. Explicitly Triggered—initiated by a human operator or another program coordinating the surveillance, such as the Intelligence Coordination Agent (ICA), described below.

Logging Modes:

Surveillance logging operates under the following modes:

1. Synchronous—logging is always turned on when surveillance is active.

2. Message Triggered—logging activity can be triggered when a certain type of message is intercepted. For example, when the message pertains to an order for more than $1,000 of merchandise.

As noted above, an LIC co-resides at nodes with each program 30 that is to be monitored by MSAs. It can be a part of the program 30 or an independent process. The LIC's purpose is to provide a venue to the program 30 to be monitored so an MSA can gather information.

Specifically, an LIC performs the following:

1. Receives the delivery of an MSA.

2. After receiving an MSA, installs or updates it according to the specifications given with the delivery. This can take the form of executing an installation script delivered with the MSA.

3. (When in covert mode) The LIC passes messages entering and leaving the program through an MSA so they can be analyzed and recorded.

4. (When in proxy mode) The LIC passes the log messages to the MSA to be forwarded to the log targets.

In order to more effectively mange the data being collected by the MSAs, one or more Intelligence Coordination Agents (“ICAs”) 16 may be deployed. An ICA is an aggregate of MSAs and has similar features as an MSA, except that it monitors the log entries being sent by MSAs and not the messaging activities of the client programs 30. The ICAs 16 are a special subset of MSAs, and can be managed and deployed by facilities supporting the MSAs. An ICA exists to monitor messaging activities that may mean very little when analyzed by individual MSAs.

Each ICA contains high-level knowledge of a set of related messaging activities as they take place across multiple parts of the network, and can control and monitor multiple MSAs for the purpose of tracking such activities. Information provided by the MSAs can be correlated and resolved into a more detailed message in a log, or can cause a concrete action to be taken. To maximize its efficiency, each ICA can be strategically placed at key locations where MSAs operate.

In the example depicted in FIG. 1, ICA1 is placed at Node 3 to collect MSA1 and MSA2 data from Nodes 1 and 2. ICA1 could, for example, be implemented to condense the data from MSA1 and MSA2 into a more concise format, compare the data, cause some action to be taken, etc.

Thus, an ICA can be very simple or extremely sophisticated. For example, it may be under the direct control of a system administrator via a GUI that simply gathers information for human review. Alternatively, it may be fully automated and able to modify its own surveillance parameters based on changing system conditions. ICAs are described in further detail below.

As noted above, deployment of the MSAs are handled using MDAs 25 (MSA Deployment Agents). In order for the MDA to deploy an MSA, it must know two things: which MSA to deploy; and where to deploy it. Utilizing the MSA Repository 14, an MSA and all its components can be easily located as the MSA is identified by a unique ID (e.g., MSA1, MSA2, etc.). Similarly, the destination node also will have a unique ID (e.g., Node 1, Node 2, etc.).

To deploy multiple MSAs to the same destination, the MSAs are grouped together and assigned a group ID. Similarly, to deploy the same MSA to multiple node locations, the node locations can be assigned to a group. Changes to group membership results in a deployment/retraction action.

The MSA Repository 14 and MSA Assignment Groups20 enable and direct the deployment process and are made up of the following components:

1. Database tables to keep track of MSAs and the components it consists of.

2. Database tables to keep track of assignment groups and the MSAs and destination LICs (Local Intelligence Contact).

3. A mechanism to generate complete (for first-time installations) or partial (for updates) MSA packages that can be passed to the MDA for deployment.

4. A mechanism to store and access actual MDA components in a file system or database.

5. A set of user or program interfaces that allows management of group membership and storage of MSAs and their components.

6. A mechanism to direct MDA activity whenever a related change happens that can result in deployment action.

The MDA 25 takes instructions from various entities (e.g., MSA Assignment Groups, Intelligence Coordination Agents, etc.) to deploy/retract/update/start/shutdown MSAs. A typical implementation will be a command line program that takes an MSA ID and an address pointing to the LIC where it is to be installed, as well as an instruction for the MDA 25 itself. Following the start of the program, the MDA 25 contacts the MSA repository 14 for the needed package.

An MDA 25 is composed of the following components.

1. A mechanism to send MSA packages to the LICs and delete MSAs remotely at the LIC.

2. A mechanism to remotely start and shutdown the MSAs.

3. A mechanism to extract MSAs from the MSA repository.

4. A mechanism to accept MSA placement requests.

Provided that an LIC has been established with the program 30 to be monitored, an MDA 25 can deploy a MSA by transferring its program code and associated configurations over the network to the LIC, which has been pre-installed as a dynamic loadable module, or a built-in module, of the program 30. The LIC may also have a component external to the program, reachable through an Inter-Process Communication service, which is included in many popular operating systems (if the external component resides on the same computer as the program), or a network connection (if the external component resides on another computer).

An LIC consists of:

1. A mechanism to capture, if desired, any messages of a supported protocol going in and out of the program 30 it monitors.

2. A mechanism to deliver a captured message to the appropriate agent for inspection.

3. A mechanism to receive, for itself, messages including but not limited to the delivery of MSA program codes and configuration files.

4. A mechanism to physically install or uninstall an MSA to and from the local file system.

5. A mechanism to grant permission to the appropriate MSA, or directly by itself, to establish a data connection to another program 30. This would typically be for the purpose of delivering reports on the messaging activity taking place on the program 30 being monitored.

Each time the MDA 25 wishes to remotely install an MSA, it will transmit a deployment package 26 to each LIC. The package 26 will consist of a number of files, some of which may be optional depending on the circumstances.

Sometimes deployment packages 26 will function as updates. For instance, if an MSA needs to be modified in a minor way, the package will only transmit the new files that will replace the old ones. At other times, certain files would have already been installed as a result of a previous MSA installation, and so the files can be omitted from the deployment package.

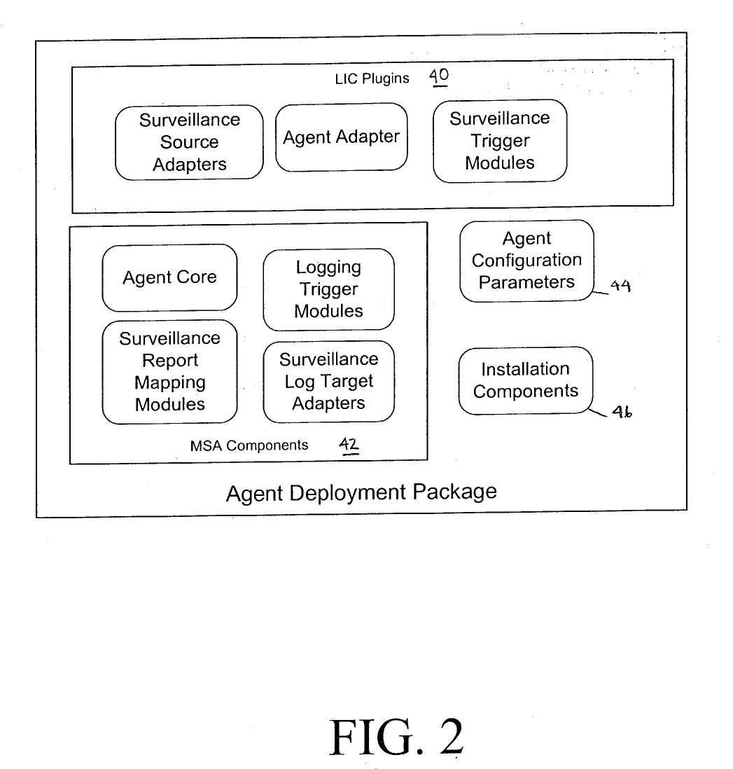

FIG. 2 depicts an overview of the deployment package contents. The deployment package may consist of a number of modules including:

1. LIC Plugins 40—these will be installed at and used by the LIC.

Surveillance Source Adapters—Provides protocol drivers that allow the LIC to capture the messaging activity using the supported protocol.

Agent Adapter—Provides the LIC a means of managing and communicating with the agent being deployed.

Surveillance Trigger Modules—Allows the LIC to detect conditions for when to activate the MSA and the means of doing so when necessary.

2. MSA Components—these will be installed as part of the MSA.

Agent Core—Any parts of the agent that remain the same for most of the agents.

Surveillance Report Mapping Modules—Decision logic on how to interpret the messages being monitored, what information to extract from these messages and what to include and how to include the specified information in the surveillance reports.

Surveillance Log Target Adapters—Allows the logging of surveillance reports using specific methods.

3. Agent Configuration Parameters 44—these will guide the MSA and LIC during installation and operation. The parameters also contain an MSA identifier that allows the MSA to be updated/controlled by the MDA 25. Included below is an example of how the parameters can be realized as an XML file.

<?xml version=“1.0” encoding=“UTF-8”?>

<MSADefinition id=“MSATest”>

<LogDefinition>

<Source id=“srcq0” protocol=“MQSeries”>

<QueueManager>THQM1</QueueManager>

<Queue>TXHB.MQSI.HW.CSIM.IN</Queue>

</Source>

<Target id=“targetq0” protocol=“MQSeries”>

<QueueManager>THQM1</QueueManager>

<Queue>TXHB.MQSI.LOG.ALIAS</Queue>

</Target>

<Comments text=“Java class to transform a HW invoice to an Mlog entry”/>

<Mapping id=“map0” type=“java” loc=“CsimLog”/>

<Comments text=“Java class to detect price condition”/>

<Comments text=“Logging will only occur when an item ordered has the gross price of 500 USD or above”/>

<LogOn id=“logtrig0” type=“message” loc=“ItemPriceTrigger” amount=“500”/>

</LogDefinition>

<Comments text=“This MSA will be active daily from 03:00 to 05:00 CST, when the transaction we wish to monitor is set to occur”/>

<Activity id=“trig0” type=“timer” loc=“LogScheduler”>

<Parameters start=“03:00” end=“05:00” zone=“CST”/>

</Activity>

</MSADefinition>

4. MSA Installation Components 46—Scripts or compiled code that can be used to perform special operations as part of the MSA installation process.

As discussed above, an MSA's code and configuration are stored in MSA Repository 14, and the user will tell the MDA 25 where to deploy MSA packages through the associations established between the MAGS and programs 30 being monitored.

The MDA 25 is also responsible for ensuring that an MSA package is properly transported to the LIC. This can be achieved by adapting a number of industry standard protocols, such as FTP, HTTP, MQSeries, TFTP. For example, to transport the MSA package using MQSeries, the LIC can be designed such that an MQSeries channel going from the MDA 25 to the LIC is established when the LIC is installed. Alternatively, there could be some default protocol adapter on pre-installed that allows the downloading of an MQSeries protocol adapter (and any number of other adapters for other protocols), which can then be used for the transportation of the MSA package.

One possible implementation utilizes an HTTP server as a mediator between the LIC and MDA. The HTTP server is established for three purposes:

1. To distribute protocol adapters to the MDA 25.

2. To bypass most firewall restrictions by channeling through port 80.

3. To uniquely identify an LIC to the MDA 25. In addition, it utilizes a unique ID that consists of a protocol-specific address and optional random strings to address conflicts.

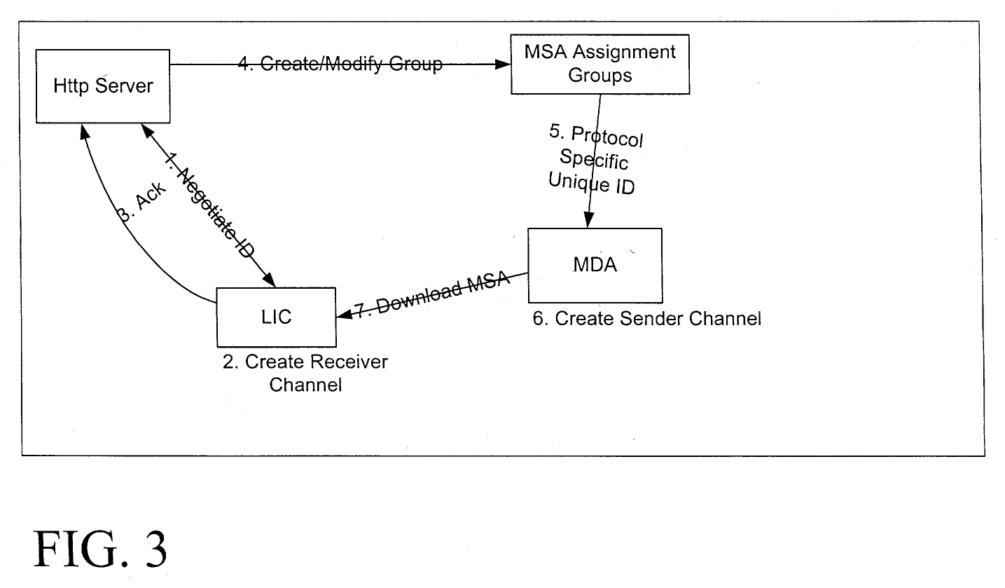

An example of this is depicted in FIG. 3. When the LIC is installed, it will download from the MSA Server 10 any protocol adapters that it can support and attempt to install them. In doing so, it will generate a unique ID for each protocol and send it to the server for verification (Step 1). If the server 10 rejects the ID, a different one is generated by inserting a random string and retrying. When the ID has been verified as unique (Step 2), the server 10 will send back a positive acknowledgment and enter the unique ID into its database, pairing it up with the protocol supported (Step 3). The LIC acknowledges back to the HTTP server, which then will allow the unique ID to be added to an MSA Assignment Group (Step 4). The MDA 25 will use such an ID to derive information on how to contact the LIC. To allow the MDA to identify an LIC that supports multiple protocols as one single entity, each time the LIC tries to verify a unique ID with the HTTP server, it also sends all the unique IDs it has already established with the other protocols (Step 5).

Before the MSA can be sent, the LIC has to prepare to receive it. The following example demonstrates such a process to establish an MQSeries receiver channel (Step 6). Having the unique ID of “THQM887:192.168.1.2(1414),” the MDA 25 can derive that the remote Queue Manager at the LIC has the name THQM887 (established by appending the random string 887 to the THQM name, which conflicts with an existing queue manager), and it can be contacted at IP Address 192.168.1.2, Port 1414.

The LIC installer can then use it to create a queue manager called THQM887, establish a receiver channel called MDA.THQM887, and then create a local queue to receive the MSA called IN.AGENT. The LIC code will then send an acknowledgment to the HTTP server and wait for the MSA to be downloaded (Step 7).

As the facilitation of MSA deployment is a primary function of each LIC, a typical implementation will minimize its impact on the operation of the program 30 being monitored. After downloading the MSA through an established application protocol such as, but not limited to, HTTP, FTP, or MQSeries, an LIC and MSA collaboratively execute the following steps to complete the deployment. Throughout the deployment process, some external installation components from the installation package may be utilized:

1. The MSA is instantiated in the local address space.

2. The MSA configuration file, which came bundled with the MSA, is read and the following parameters regarding the operation of the MSA are extracted: the surveillance sources, log targets, surveillance report mapping, surveillance triggers, and logging mode. If parameters are missing, implementation specific defaults will be used.

3. The surveillance sources are registered in a lookup table and pointers to the MSA are established such that the LIC will capture messages from the surveillance sources and present them to the MSA for analysis.

4. The log targets are established and/or configured for usage, as needed, through a compiled program or shell script. This may include verifying that the targets specified exist and that they are operational and, if not, take remedial steps to ensure that they are. For example, a protocol such as MQSeries will require the specific configuration of Channels/Queue Managers/Queues before it can be used as a message transport.

5. The surveillance report mappings, which can be implemented as program code (e.g., in Java, XSL, C, or Perl), are installed. Every mapping is provided to the MSA through a uniform interface, such that one can be exchanged for another as need arises. Each surveillance mapping will contain instructions on how to transform a message conforming to a grammar M to a log entry conforming to a grammar L. In addition, each surveillance mapping is associated with a log target as specified in the MSA configuration; thus, hooks are set up such that attempts to write to a log target automatically lead to the corresponding transformation. Upon installation, surveillance report mappings do not have to be loaded into memory until the actual need arises based on the trigger conditions.

6. The surveillance triggers are installed according to the instructions specified in the configuration file. On an operating system with the appropriate facility, a scheduler service can be employed to provide a timer trigger. At installation, the scheduler is configured. At the appropriate time, the LIC can be signaled to activate the dormant MSA or the MSA can be executed directly as an external program. Alternatively, the LIC itself can provide a timer relying on the system clock. For event-based triggering, an event detection module must be installed at the LIC such that when the event arises the LIC can activate the MSA. Finally, an explicit trigger will require the deployment of a external triggering interface at the LIC. These LIC facilities are established during installation and the associations between the triggers and their corresponding MSAs are stored in a look up table.

7. The logging triggers will also be installed at the LIC in the form of logging trigger modules. Such a module takes a normal message as a parameter and determines if it is to be logged, based on the content of the message. However, since they are not needed unless the MSA is active, they can initially be stored on disk and merely verifying their presence and validity will suffice at installation.

As described above, the MSA Repository 14 can keep track of when a specific MSA needs to be updated, and instruct the MDA 25 to propagate the updates to the LICs where the MSAs are installed. The LICs will identify the local MSA by matching the MSA ID in the configuration file, and overwrite the specified components. Retraction of the MSA or specific components can be accomplished through a configuration file that contains retraction instructions.

Next, the post-deployment operation of the LIC and the MSA are described in further detail. As noted, an LIC Contact can operate in two modes, depending on the need of the program 30 being monitored. A program 30 that has total control over its own surveillance reports needs to speak to the LIC over a proxy mode interface, which works as follows:

1. Every time the program 30 being monitored formulates a message M, and a surveillance report message R concerning the message M.

2. After message M is passed through the usual messaging channel, the surveillance report R is sent to the LIC for distribution.

3. Depending on the configuration parameters, the LIC determines the log target for R and sends it there through a message channel that may not be the same as that used by M.

Note that a proxy mode LIC works more or less like a pass through mechanism for message logging in the traditional sense, with the added flexibility that the log targets can be reconfigured dynamically through the typical MSA configuration mechanism. It should generally be used sparingly where the performance impact of the other mode of operation, discussed below, is unacceptable.

When an LIC operates in “covert mode,” the primary functions of the program 30 whose messaging activity is being monitored can be decoupled from the monitoring activity and changed independently of one another. This provides a primary advantage in that the party responsible for the monitoring has unilateral control over what information to obtain. The trade off is that the messaging activity lies open—due to engineering choice—to the monitoring party, and it may require more complex implementations to safeguard the security of the data:

1. Message M is formulated by the program 30 being monitored and passed to the usual messaging mechanism.

2. Without intervention from the creator of M, the messaging mechanism passes M to the LIC, while it allows M to continue towards its original destination.

3. The LIC, utilizing its internal logic, routes M through to the appropriate MSA.

4. An MSA takes message M and transforms it into a message R in the appropriate format for a surveillance report.

5. The surveillance report is sent to the appropriate log targets defined in the MSA configuration.

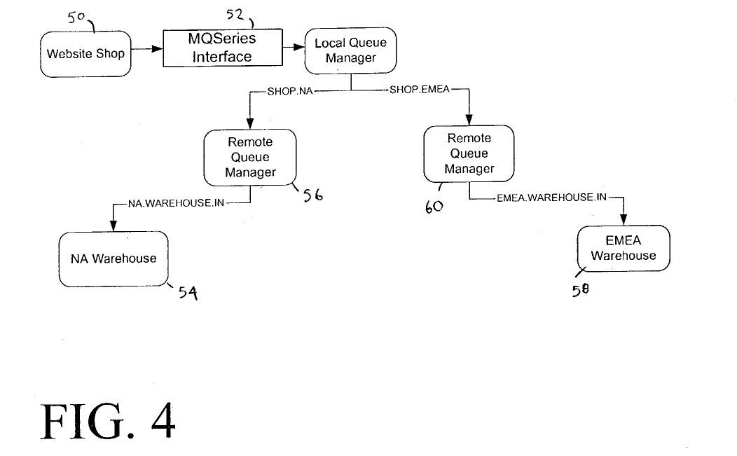

FIG. 4 illustrates an environment suitable for a covert mode implementation. The implementation utilizes the MSA in the context of an order fulfillment system that operates across different locales over a wide area network. The individual parts of the system are knit together through an enterprise messaging system. An order is entered from a Website Shop 50, which acts as an interface 52 to the system infrastructure. The order passes through this interface 52, and depending on the shipping address, is sent to a North American Warehouse (NA) 54 through the SHOP.NA queue 56 or a European (EMEA) Warehouse 58 through the SHOP.EMEA queue 60. The queue managers are responsible for ensuring that the message gets to the intended targets.

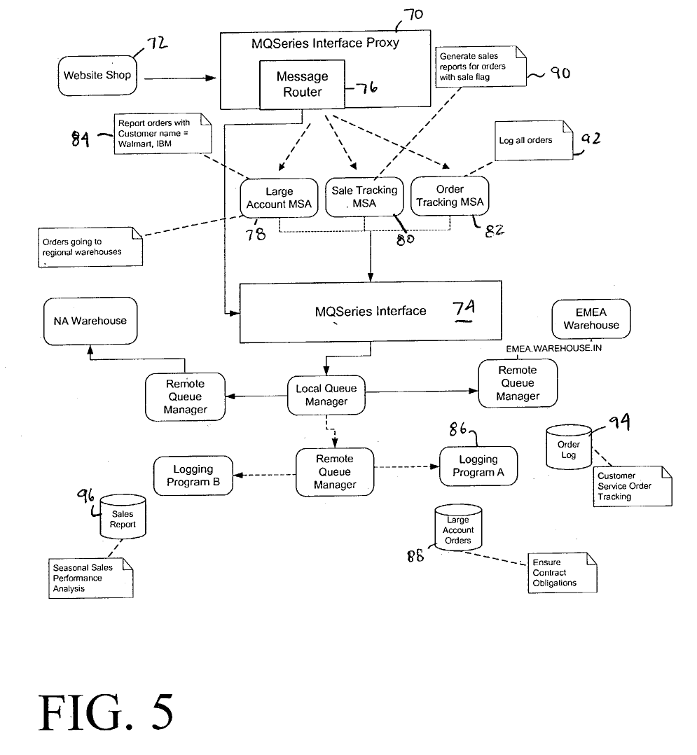

In FIG. 5, an MQSeries Interface Proxy 70 is inserted between the Website Shop 72 and the MQSeries Interface 74. This is a one-time installation that may require some downtime on the Website Shop 72. The MQSeries Interface Proxy 70 is intended to be a drop-in replacement for the original interface, and the Shop 72 cannot distinguish it from the original interface.

Contained within the proxy is a message router 76, which has an internal routing table, filled with information from various MSA configuration files. Each individual MSA is an independent process connected to the proxy 70 through an inter-process configuration channel. In addition, the MQSeries Interface 74 is linked to the proxy 70 as a dynamically loadable library, allowing order messages to reach their original destinations without interruption, while copies of the orders are dispatched to the individual MSAs: the Large Account MSA 78, Sales Tracking MSA 80, and Order Tracking MSA 82 . . . are each responsible for monitoring specific parts of the order transaction.

The Large Account MSA 78 monitors the customer name from each order 84 to identify those from selected customers, and enters relevant order data into a remote database 88 through logging program A 86. The gathered data can help ensure that contract obligations with large customers are met.

The Sales Tracking MSA 80 can gather information useful for sales performance analysis 90 such as comparing the effectiveness of various seasonal and holiday sales whose orders are marked with a “sale” flag for identification purposes. Such analysis can be stored in a database 96 to help determine pricing and inventory strategies during future sales.

Finally, the Order Tracking MSA 82 will indiscriminately record all the orders 92 entered into the system. Such a database 94 can be warehoused and archived for historical purposes. Moreover, a Customer Service representative will be able to extract detailed order information from the database upon customer inquiry.

When an MSA issues a surveillance report, the reports are logged in a data store. The data can then be utilized for quantitative or qualitative analysis at a later time. For example, a retail chain can use statistics derived from sales-related data to generate a chart showing the revenues generated throughout different parts of a day in various retail stores. To ensure customer orders are fulfilled, a computer manufacturer can place MSAs at various points in its business process infrastructure to track the movement of each order from receipt of the order through manufacturing in the factory, to shipping, and finally to billing and receiving payment.

Sometimes the surveillance reports need to be correlated with each other and/or acted upon immediately, tasks that cannot be accomplished efficiently by logging onto a data store. These types of reports need to be gathered and processed by a capable program. The Intelligence Coordination Agent (ICA), is a convenient choice, given the flexibility of MSA deployment and configuration. An ICA is essentially an MSA, plus the following components:

1. Temporary data storage—for the surveillance reports gathered from the MSAs

2. A surveillance report processor—activated by incoming reports, that periodically applies a pattern search to the stored surveillance reports and, when a pattern is found, identifies the elements related to the pattern.

3. A surveillance report generator—which is triggered when a pattern is found by the surveillance report processor, and is responsible for taking the elements of the pattern and extracting the necessary information and mapping them to a surveillance report format to be accepted by a higher level ICA or a log target.

4. A coordination module—that carries out intermediate action, also triggered when a pattern is found. The surveillance report generation is a specific type of task carried out by the coordination module. Other coordinating tasks include: formulating a new template to be sent to the MDA for redistribution, sending an e-mail alert to a system administrator, entering data into a local database, etc.

One example of the operation of the ICA is the following scenario. An electronic order needs to follow a path from point A to point E, to be processed through various enterprise systems. The ICA can act as an overseer to the entire process to ensure that an order entering A eventually gets processed by E in a predicted amount of time. But, due to network outage or failure of one of the intermediate systems, it was not able to reach its destination.

To have more detailed information as to where the failure occurred, it is necessary to have MSAs available at each point along the path, and have them report “sightings” to the supervisor ICA. For the same reasons that MSAs are “mobile,” these monitoring units would be deployed dynamically so that they don't use pipeline resource unnecessarily.

The coordination process works as follows (using the scenario described above):

1. An ICA detects a lapse in the order fulfillment pipeline.

2. In response, it deploys MSAs to each point that requires monitoring in a binary search fashion

3. As part of the installation process, the MSAs examine the existing communication channels and try to determine what happened to the existing order. If the cause is determined, it can work out a remedy for the problem.

4. The MSAs are installed along the path to ensure that future orders go through ok.

5. Upon examination by a system administrator, the extra MSAs may be retracted.

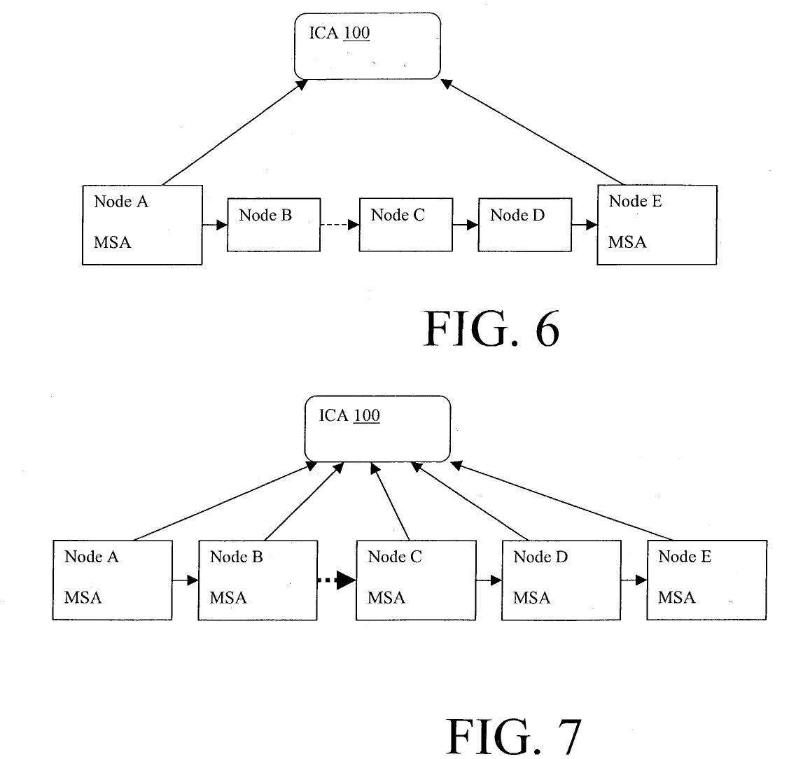

As shown in FIG. 6, the ICA 100 monitors communications between nodes A and E, with an MSA only at nodes A and E. An error may occur in any of the intermediate systems, e.g., between nodes B and C. In FIG. 7, with MSAs deployed to each intermediate system, an error can be automatically pinpointed to facilitate speedy recovery.

Following this example, the ICA 100 can be utilized as follows. Message M going from nodes A to B is captured by the MSA at node A, which reports the event to the ICA with surveillance report R_{A}. The ICA's 100 internal logic recognizes that report R_{A} must be followed up in T minutes with a report R_{E}. As a result, the transaction initiated completes by message N reaching node E. The ICA saves R_{A} in a database and waits for the MSA at node E to send it R_{E}. It starts a T minute countdown for the transaction to complete.

Each time ICA 100 receives a surveillance report from node E, it checks if it is the R_{E} it is expecting. If it is received within the T minute interval, the timer is stopped and nothing happens. If the timer expires, the ICA 100 derives from R_{A} a surveillance report and sends it to its own log target. The ICA 100 coordinates with the MDA 25 and deploys additional MSAs at nodes B, C, and D. The local installation process at node B identifies an error condition in the link going to node C; this is reported to the ICA when the MSA initializes. The ICA 100 logs the error reported by the MSA at node B, and in the meantime starts receiving reports from nodes B, C, and D, and uses these to track possible errors in the future. When the system administrator has resolved the error condition, the MSAs at nodes B, C, and D can be shut down or retracted manually.

Although ICAs can be deployed to any location with an LIC (Local Intelligence Contact) present, the fact that its operation depends on the MSAs means that the ICA needs to be “bound” to specific MSAs deployed to specific locations. Deployment of an ICA needs to be followed by the deployment of the MSAs it depends on, if they are not already deployed. Removal of an ICA means that the MSAs need to be retracted if they don't have other log targets to report to. If they have other log targets, the set of log targets pointing to the ICA need to be removed.

This processed can be automated by including MSA assignment groups—essentially the glue between MSAs and their deployment locations—to an ICA as part of its configuration. All the MSAs in such a group will share a common log target that points each ICA to the group they belong to, allowing the MSAs to feed surveillance reports to the ICA regardless of its physical position. In turn, the ICAs can keep track of which MSA it can deploy—it is up to the deployed ICA “if and when” to deploy the individual MSAs as it sees fit.

It is understood that the systems, functions, mechanisms, methods, and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. The present invention can also be embedded in a computer program product, which comprises all the features enabling the implementation of the methods and functions described herein, and which—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of the invention has been presented for purposes of illustration and description. They are not intended to be exhaustive or to limit the invention to the precise form disclosed, and obviously many modifications and variations are possible in light of the above teachings. Such modifications and variations that are apparent to a person skilled in the art are intended to be included within the scope of this invention as defined by the accompanying claims.

1. A system for implementing message flow monitoring in a distributed network, comprising:
a repository of mobile surveillance agents (MSAs), wherein each MSA includes program code for monitoring a client program at a remote node in the distributed network and generating a surveillance report;
a deployment system for deploying the MSAs to remote nodes; and
a local intelligence contact (LIC) preloaded at each remote node for receiving a deployed MSA at the remote node.

2. The system of claim 1, wherein each MSA includes a set of logging parameters that controls the monitoring operation.

3. The system of claim 1, wherein the deployment system generates a deployment package that includes a set of LIC plugins, a set of MSA components, configuration information for the MSA, and installation code for the MSA.

4. The system of claim 1, wherein the deployment system includes a deployment agent that specifies a protocol for transporting an MSA to a node.

5. The system of claim 1, wherein the LIC preloaded at each remote node further includes a mechanism for distributing messages from the client program to the MSA.

6. The system of claim 5, wherein the LIC operates in a proxy mode that is decoupled from the client program.

7. The system of claim 5, wherein the LIC operates in a covert mode that is integrated into the client program.

8. The system of claim 1, further comprising an intelligence coordination agent (ICA) installed at a node in the network, wherein the ICA monitors surveillance reports generated by at least one MSA.

9. The system of claim 8, wherein the ICA can cause an MSA to be deployed.

10. The system of claim 8, wherein the ICA includes a system for searching for patterns in a surveillance report.

11. The system of claim 1, further comprising a grouping system for grouping a set of client programs with one MSA.

12. A method for monitoring message flows in a distributed network, comprising:
creating a mobile surveillance agent (MSA);
storing the MSA in a repository;
loading a local intelligence contact (LIC) at a remote node in the distributed network;
deploying the MSA to the remote node using the LIC to coordinate the deployment;
monitoring a client program at the remote node with the MSA; and
generating a surveillance report from the MSA.

13. The method of claim 12, wherein the monitoring step includes:
using the LIC to collect messages from the client program; and
passing the messages to the MSA.

14. The method of claim 12, including the further step of:
forwarding the surveillance report to a log target elsewhere within the distributed network.

15. The method of claim 12, including the further steps of:
deploying an intelligence coordination agent (ICA) at a second node in the distributed network, wherein the ICA includes an analysis system; and
forwarding the surveillance report from the MSA to the ICA for analysis.

16. The method of claim 15, including the further step of:
altering a behavior of the MSA based on the analysis.

17. A program product stored on a recordable medium, which when executed, implements message monitoring over a distributed network, wherein the program product comprises:
means for storing a plurality of mobile surveillance agents (MSAs), wherein each MSA includes program code for monitoring a client program at a remote node in the distributed network and generating a surveillance report;
means for deploying the MSAs to remote nodes; and
means for coordinating installation of a deployed MSA at the remote nodes.

18. The program product of claim 17, further comprising grouping means for grouping a set of client programs with one MSA.

19. An architecture for monitoring messages across a distributed network, comprising:
(a) a server, wherein the server includes:
a system for creating mobile surveillance agents (MSAs);
a repository for storing the MSAs; and
a deployment system for deploying MSAs throughout the distributed network;
(b) a plurality of remote nodes within the distributed network, wherein each remote node includes:
a client program executing on the remote node; and
a local intelligence agent (LIC) for coordinating an installation of an MSA deployed to the remote node, and for distributing messages from the client program to the MSA installed at the remote node; and
(c) at least one log target for receiving surveillance reports from MSAs deployed throughout the distributed network.

20. The architecture of claim 19, wherein each MSA includes a set of logging parameters that controls a monitoring operation of the messages received from the client program.

21. The architecture of claim 19, wherein the deployment system generates a deployment package that includes a set of LIC plugins, a set of MSA components, configuration information for the MSA, and installation code for the MSA.

22. The architecture of claim 19, wherein the deployment system includes a deployment agent that specifies a protocol for transporting an MSA to a remote node.

23. The architecture of claim 19, wherein the LIC operates in a proxy mode that is decoupled from the client program.

24. The architecture of claim 19, wherein the LIC operates in a covert mode that is integrated into the client program.

25. The architecture of claim 19, further comprising an intelligence coordination agent (ICA) installed at a remote node in the network, wherein the ICA monitors surveillance reports generated by at least one MSA.

26. The architecture of claim 25, wherein the ICA can cause an MSA to be deployed.

27. The architecture of claim 25, wherein the ICA includes a system for searching for patterns in a surveillance report.

28. The architecture of claim 19, further comprising a grouping system for grouping a set of client programs with one MSA.
